(19) United States
(12) Patent Application Publication
(10) Pub. No.: US 2026/0072205 A1
(43) Pub. Date: Mar. 12, 2026

(54) DISPLAY DEVICE

(71) Applicant: Japan Display Inc., Tokyo (JP)

(72) Inventor: Kentaro OKUYAMA, Tokyo (JP)

(73) Assignee: Japan Display Inc., Tokyo (JP)

(21) Appl. No.: 19/320,505

(22) Filed: Sep. 5, 2025

(30) Foreign Application Priority Data
Sep. 6, 2024 (JP) 2024-153898

(51) Int. Cl. F21V 8/00

(52) U.S. Cl. CPC G02B 6/0018; G02B 6/003

(57) ABSTRACT

Performance of a device is improved. A light guide plate of a display device includes a side surface (first side surface) facing a light source unit and extending along an X direction, a second side surface continuous with a first end of the first side surface and forming a curved surface, and a third side surface continuous with a second end of the first side surface and forming a curved surface. The side surface includes a first region, a region (second region) located between the first region and the second side surface and continuous with the second side surface, and a third region located between the first region and the third side surface and continuous with the third side surface. The region and the third region each include a plurality of protrusions capable of changing a traveling direction of light.

### CROSS-REFERENCE TO RELATED APPLICATIONS

The present application claims priority to Japanese Patent Application No. 2024-153898 filed on Sep. 6, 2024, the disclosure of which is incorporated herein by reference.

### BACKGROUND

The present invention relates to a display device.

As a display device, there is a display device including a light emitting module that includes packages in each of which one red emitting element, one green emitting element, and one blue light emitting element are packaged and a light guide provided at a position facing a light emitting point of the light emitting module (see Japanese Patent Application Laid-open Publication No. 2021-33043 (Patent Document 1)).

The inventor of the present application has been developing a transparent display device that enables an observer to recognize a display image and a background in an overlapping state. The planar shape of a display device is generally a quadrangle, but there is a demand for a display panel having a planar shape other than the quadrangle from the viewpoint of designability, for example.

However, it has been found that, in the case of the display panel having a planar shape other than the quadrangle, the density of light incident on the light guide plate is not uniform, and the display quality may be lowered.

### SUMMARY

A display device according to an aspect of the present invention includes a first substrate including a first front surface and a first back surface on an opposite side of the first front surface, a liquid crystal layer arranged on the first front surface of the first substrate, a light guide plate including a second back surface facing the first front surface with the liquid crystal layer interposed therebetween and a second front surface on an opposite side of the second back surface, a display area located at a position overlapping with a part of the light guide plate, and a light source unit including a plurality of light emitting elements. The light guide plate includes a first side surface facing the light source unit and extending along a first direction, a second side surface continuous with a first end of the first side surface and forming a curved surface, and a third side surface continuous with a second end of the first side surface and forming a curved surface. The first side surface includes a first region, a second region located between the first region and the second side surface and continuous with the second side surface, and a third region located between the first region and the third side surface and continuous with the third side surface. The second region and the third region each include a plurality of protrusions capable of changing a traveling direction of light.

### BRIEF DESCRIPTION OF THE DRAWINGS

FIG. 1 is an explanatory diagram illustrating a positional relationship in a case where a viewer located on one surface side of a transparent display panel device visually recognizes a background located on the opposite surface side through the transparent display panel device.

FIG. 2 is an explanatory diagram illustrating an example of the background visually recognized through the transparent display panel device.

FIG. 3 is a plan view illustrating an example of the transparent display panel illustrated in FIG. 1.

FIG. 4 is a cross-sectional view taken along line A-A in FIG. 3.

FIG. 5 is a circuit block diagram illustrating an example of a circuit included in the display panel in FIG. 3.

FIG. 6 is a plan view schematically illustrating a path of light entering a light guide plate in a display panel, which is an examination example with respect to FIG. 3.

FIG. 7 is an enlarged plan view illustrating, in an enlarged manner, a periphery of one end portion of a side surface facing a light source unit in the light guide plate illustrated in FIG. 3.

FIG. 8 is an enlarged plan view illustrating, in an enlarged manner, a periphery of the other end portion of the side surface facing the light source unit in the light guide plate illustrated in FIG. 3.

FIG. 9 is a perspective view illustrating an example of a plurality of protrusions formed on the light guide plate.

FIG. 10 is a perspective view illustrating an example of the plurality of protrusions formed on the light guide plate.

FIG. 11 is an enlarged cross-sectional view taken along line B-B in FIG. 9 or line C-C in FIG. 10.

FIG. 12 is a perspective view illustrating a modification of the plurality of protrusions formed on the light guide plate.

FIG. 13 is a perspective view illustrating a modification of the plurality of protrusions formed on the light guide plate.

FIG. 14 is an enlarged cross-sectional view taken along line D-D in FIG. 12 or line E-E in FIG. 13.

FIG. 15 is an enlarged cross-sectional view illustrating a modification of the plurality of protrusions illustrated in FIG. 11.

FIG. 16 is a perspective view illustrating another modification of the plurality of protrusions illustrated in FIG. 12.

FIG. 17 is an enlarged cross-sectional view taken along line F-F in FIG. 16.

FIG. 18 is an enlarged cross-sectional view illustrating an example of a shape of a protrusion in a region opposite the region illustrated in FIG. 17.

FIG. 19 is an enlarged cross-sectional view illustrating another modification to FIG. 11.

FIG. 20 is an enlarged cross-sectional view illustrating another modification to FIG. 11.

FIG. 21 is an enlarged cross-sectional view illustrating another modification to FIG. 11.

### DETAILED DESCRIPTION

Hereinbelow, embodiments of the present invention will be described with reference to the drawings. Note that the disclosure is merely an example, and appropriate modifications that can be easily conceived by those skilled in the art while maintaining the gist of the invention are naturally included in the scope of the present invention. In addition, in order to make the description clearer, schematic width, thickness, shape, and the like, which are different from the actual ones, may be illustrated in the drawings, but they are merely examples and do not limit the interpretation of the present invention. Furthermore, in the present specification and each drawing, similar elements to those described in the previously mentioned drawings are denoted by the same or related reference signs, and a detailed description thereof may be appropriately omitted.

In the following embodiments, a liquid crystal display device that displays an image using scattering of visible light due to liquid crystal molecules will be described as an example of a display panel used in combination with a glass plate.

The liquid crystal display device is a device that forms a display image by changing the orientation of molecules contained in the liquid crystal layer, and requires a light source. In the embodiments described below, the light source is provided separately from the display panel. Therefore, in the following, the display panel and the light source module that supplies visible light to the display panel will be described separately.

### Transparent Display Panel

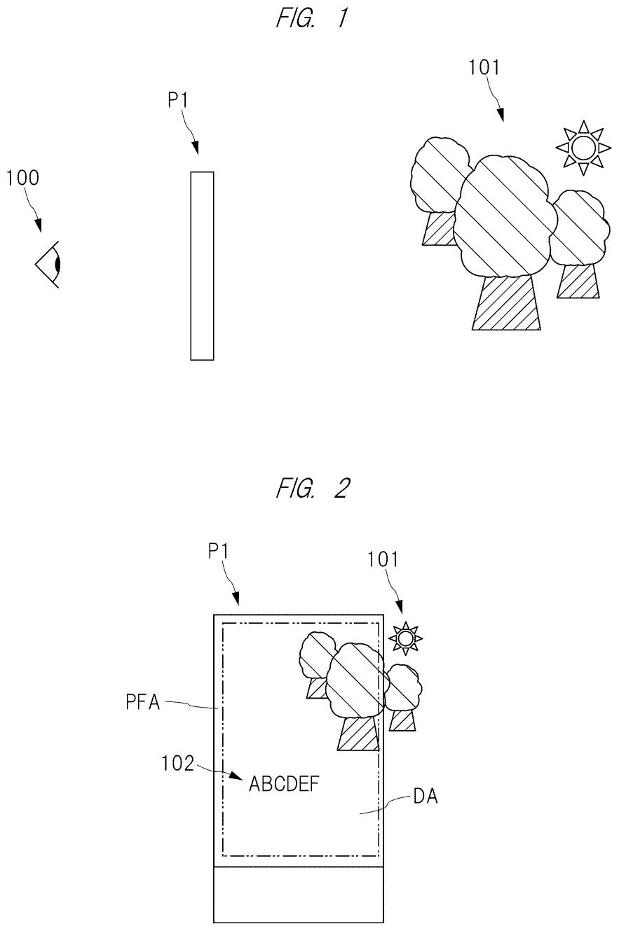

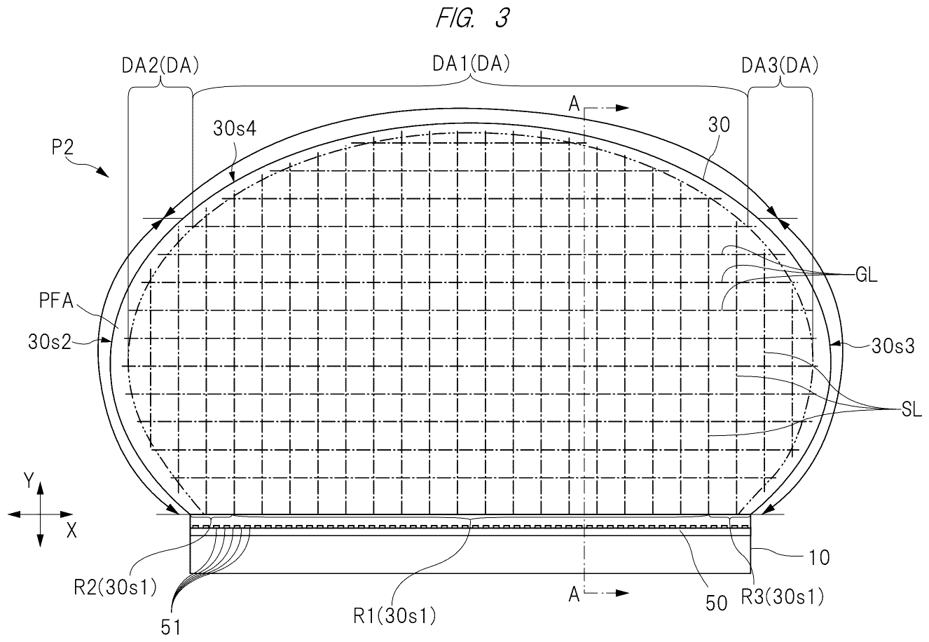

First, features of a so-called transparent display panel will be described. FIG. 1 is an explanatory diagram illustrating a positional relationship in a case where a viewer located on one surface side of a transparent display panel visually recognizes a background located on the opposite surface side through the transparent display panel. FIG. 2 is an explanatory diagram illustrating an example of the background visually recognized through the transparent display panel. Note that, although a display panel P2 according to the present embodiment does not have a quadrangular planar shape as illustrated in FIG. 3 described below, description will be provided in FIGS. 1 and 2, using a display panel P1 having a quadrangular planar shape as an example of a transparent display panel.

The display panel P1 illustrated in FIGS. 1 and 2 is a transparent display panel. As illustrated in FIG. 1, in a case where an observer 100 looks at, from one side of the display panel P1, the other side thereof, a background 101 is visually recognized through the display panel P1. As illustrated in FIG. 2, the display panel P1 includes a display area DA and a peripheral area PFA located outside the display area DA. The display panel P1 can display an image 102 on the display area DA. In FIG. 2, characters are illustrated as an example of the image 102. However, the image 102 is not limited to characters, and may be a figure, a photograph, or the like. In addition, the image 102 is not limited to a still image, and may be a moving image. The observer 100 (see FIG. 1) can visually recognize both the image 102 displayed on the display area DA of the display panel P1 and the background 101 at the same time.

In a case where both the display area DA and the peripheral area PFA illustrated in FIG. 2 transmit light, the observer can visually recognize the entire background 101 without a feeling of strangeness. On the other hand, in a case where the peripheral area PFA has a light shielding property that prevents light transmission, a part of the background 101 visually recognized through the display panel P1 is shielded by the peripheral area PFA, which may make the observer 100 feel strange. In this manner, in a case where the transparent display panel is the display panel P1, the display area DA and the peripheral area PFA each preferably have visible light transmission characteristics. In addition, from the viewpoint of visually recognizing the background 101 without a feeling of strangeness, it is particularly preferable to make the respective visible light transmission characteristics of the display area DA and the peripheral area PFA similar.

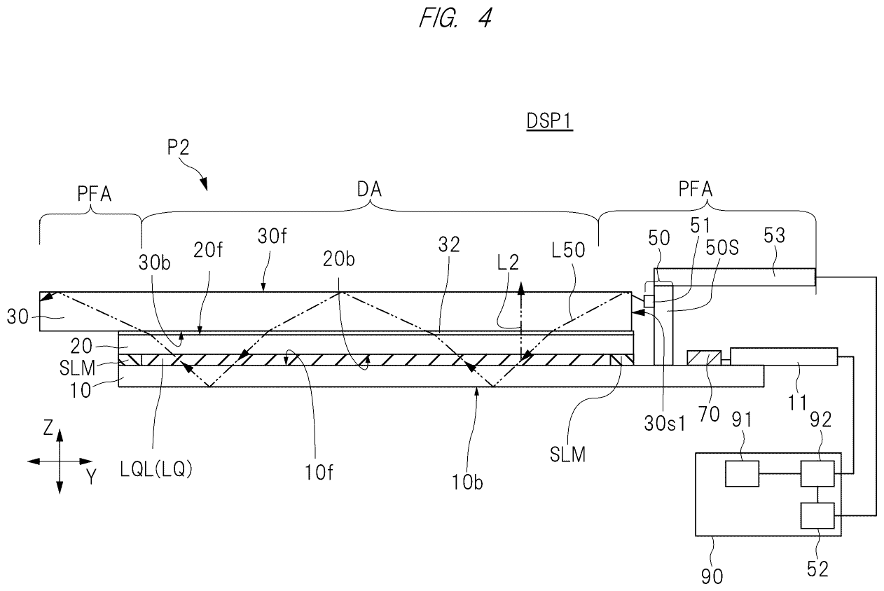

FIG. 3 is a plan view illustrating an example of a transparent display panel according to the present embodiment. In FIG. 3, the boundary between the display area DA and the peripheral area PFA is indicated by the two-dot chain line. In FIG. 3, a part (more specifically, a gate line GL and a source line SL) of the signal lines for transmitting a signal for driving the liquid crystal in the circuit included in the display panel P2 is schematically illustrated by the one-dot chain line. FIG. 4 is an enlarged cross-sectional view taken along line A-A illustrated in FIG. 3. In the subsequent drawings including FIGS. 3 and 4, a direction along a thickness direction of the display panel P2 is referred to as a Z direction, an extending direction of one side of the display panel P2 in an X-Y plane orthogonal to the Z direction is referred to as an X direction, and a direction intersecting with the X direction is referred to as a Y direction.

The display panel P2 illustrated in FIG. 3 is different from the display panel P1 illustrated in FIGS. 1 and 2 in that the planar shape is not a quadrangle. However, the display panel P2 is similar to the display panel P1 illustrated in FIGS. 1 and 2 in that the display panel P2 is a transparent display panel.

As illustrated in FIG. 4, the display panel P2 according to the present embodiment includes a substrate (array substrate) 10, a substrate (counter substrate) 20, a light guide plate 30, a light source unit 50, and a drive circuit 70 (see FIG. 4). As illustrated in FIG. 4, the display panel P2 is a display device that enables emitted light L2 to be visually recognized from the outside without passing through a polarizing plate.

In a case of constituting a display device DSP1 (see FIG. 4), for example, a control circuit, a wiring board connected to the display panel P2, a housing, or the like may be included in addition to each unit included in the display panel P2 illustrated in FIG. 3. In FIG. 3, units other than the display panel P2 are not illustrated. FIG. 4 schematically illustrates wiring boards 11 and 53 connected to the display panel P2, and an example of a circuit (light source control unit 52 and control unit 90). On the other hand, the housing is not illustrated in FIG. 4, either.

The display panel P2 includes the display area DA in which an image is formed according to an input signal supplied from the outside, and the peripheral area (frame area) PFA around the display area DA. The display area DA is an effective area in which the display panel P2 displays an image in plan view of the display surface. The substrate 10, the substrate 20, and the light guide plate 30 are each located at a position overlapping with the display area DA in plan view.

In general, the shape of the display area DA is often a quadrangle like the display panel P1 illustrated in FIG. 2. In the case of the present embodiment, the display panel P2 includes the non-quadrangular display area DA in plan view. In the case of the example illustrated in FIG. 3, the display area DA has an elliptical shape whose part is missing. Specifically, the display area DA has an elliptical shape which includes a chord parallel to the long diameter of the elliptical shape and whose part is missing.

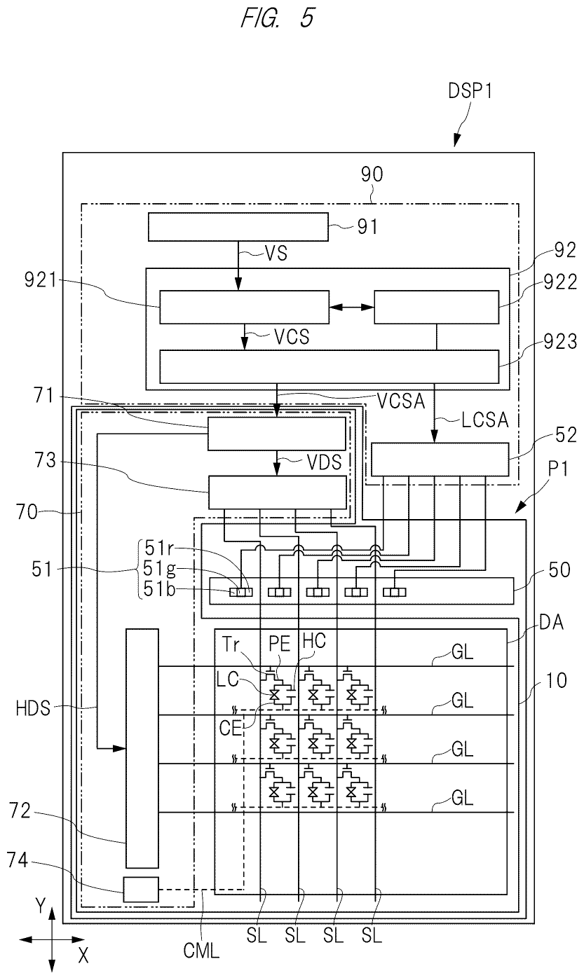

As illustrated in FIG. 4, the display panel P2 includes the substrate 10 and the substrate 20 bonded to each other so as to face each other with a liquid crystal layer LQL interposed therebetween. The substrate 10 and the substrate 20 are arranged in the Z direction, which is the thickness direction of the display panel P2. In other words, the substrate 10 and the substrate 20 face each other in the thickness direction (Z direction) of the display panel P2. The substrate 10 has a front surface (a main surface, or a surface) 10f facing the liquid crystal layer LQL (and the substrate 20). Further, the substrate 20 has a back surface (a main surface, or a surface) 20b facing the front surface 10f of the substrate 10 (and the liquid crystal layer LQL). The substrate 10 is an array substrate in which a plurality of transistors (transistor elements) as switching elements (active elements) Tr (see FIG. 5) is arranged in an array form. The substrate 20 is a substrate provided on the display surface side. The substrate 20 can be rephrased as a counter substrate because the substrate 20 is a substrate arranged to face the array substrate.

The display panel P2 further includes the light guide plate 30. The light guide plate 30 is, for example, a glass substrate made of glass. The light guide plate 30 includes a back surface 30b facing the front surface 10f via the liquid crystal layer LQL (specifically, via the liquid crystal layer LQL and the substrate 20) and a front surface 30f on the opposite side of the back surface 30b.

The light guide plate 30 includes a side surface 30s1 facing the light source unit 50. The light guide plate 30 is bonded and fixed to the substrate 20 via an adhesive layer 32. At least in the display area DA, the gap between the light guide plate 30 and the substrate 20 is filled with the adhesive layer 32. In the example illustrated in FIG. 4, the adhesive layer 32 adheres to the entire back surface 30b of the light guide plate 30.

The adhesive layer 32 is made of a transparent resin material capable of transmitting visible light. Examples of the visible light transmissive adhesive layer 32 include a transparent adhesive sheet called optical clear adhesive (OCA) formed to have a sheet shape, and optical clear resin (OCR) used by curing a liquid transparent adhesive.

The liquid crystal layer LQL including a liquid crystal LQ is between the front surface 10f of the substrate 10 and the back surface 20b of the substrate 20. The liquid crystal layer LQL is an optical modulation element. The display panel P2 has a function of modulating light passing through the liquid crystal layer LQL by controlling a state of an electric field formed around the liquid crystal layer LQL via the switching element described above. The display area DA of the display panel P2 overlaps with the liquid crystal layer LQL as illustrated in FIG. 4.

In addition, the substrate 10 and the substrate 20 are bonded via a seal unit (sealing material) SLM. The seal unit SLM is arranged in the peripheral area PFA so as to surround the periphery of the display area DA. Inside the seal unit SLM, the liquid crystal layer LQL is provided. The seal unit SLM serves as a seal for enclosing a liquid crystal between the substrate 10 and the substrate 20. In addition, the seal unit SLM serves as an adhesive material for bonding the substrate 10 and the substrate 20.

In the example illustrated in FIG. 4, a wiring board 53 for a light source is connected to the light source unit 50. The wiring board 53 is a wiring board having flexibility called a flexible wiring board. The drive circuit 70 is mounted on the substrate 10. The optical path of light L50 emitted from the light source unit 50 will be described below.

The light source unit 50 is fixed on the substrate 10. The light source unit 50 includes a substrate 50S and a plurality of light emitting elements 51 mounted on the substrate 50S. Each of the plurality of light emitting elements 51 illustrated in FIG. 3 is arranged at a position facing the side surface 30s1 of the light guide plate 30. Accordingly, the light L50 emitted from the light emitting element 51 can be incident on the light guide plate 30 through the side surface 30s1. In the example illustrated in FIG. 4, the substrate 50S of the light source unit 50 is connected to the wiring board 53. Each of the plurality of light emitting elements 51 illustrated in FIG. 3 is electrically connected to the wiring board 53 via the substrate 50S.

Each of the plurality of light emitting elements 51 illustrated in FIG. 3 is, for example, a light emitting diode element. In the example illustrated in FIG. 3, the plurality of light emitting elements 51 is linearly arranged along the X direction.

Next, the optical path of light emitted from the light source unit 50 of the display panel P2 will be described with reference to FIG. 4. As schematically illustrated by the two-dot chain line in FIG. 4, the light (light source light) L50 emitted from the light source unit 50 is incident on the liquid crystal layer LQL via the light guide plate 30. While being reflected by the back surface 10b of the substrate 10 and the front surface 30f of the light guide plate 30, the light propagates in a direction away from the side surface 30s1. In the propagation path of the light L50, the back surface 10b of the substrate 10 and the front surface 30f of the light guide plate 30 are interfaces between a medium having a large refractive index and a medium having a small refractive index. Therefore, in a case where the incident angle at which the light L50 is incident on the front surface 20f and the back surface 10b is larger than the critical angle, the light L50 is totally reflected by the front surface 20f and the back surface 10b.

The liquid crystal LQ is a polymer dispersed liquid crystal LC (see FIG. 5), and contains a liquid crystalline polymer and liquid crystal molecules. The liquid crystalline polymer is formed in a streak shape, and the liquid crystal molecules are dispersed in gaps of the liquid crystalline polymer. The liquid crystalline polymer and the liquid crystal molecules each have optical anisotropy or refractive index anisotropy. The responsiveness of the liquid crystalline polymer to an electric field is lower than the responsiveness of the liquid crystal molecules to an electric field. The alignment direction of the liquid crystalline polymer hardly changes regardless of the presence or absence of the electric field.

On the other hand, the alignment direction of the liquid crystal molecules changes according to the electric field in a state where a high voltage equal to or higher than the threshold value is applied to the liquid crystal LQ. In a state where no voltage is applied to the liquid crystal LQ, the optical axes of the liquid crystalline polymer and the liquid crystal molecules are parallel to each other, and the light L50 incident on the liquid crystal layer LQL is hardly scattered and is transmitted in the liquid crystal layer LQL (transparent state). In a state where a voltage is applied to the liquid crystal LQ, the optical axes of the liquid crystalline polymer and the liquid crystal molecules cross each other, and the light L50 incident on the liquid crystal LQ is scattered in the liquid crystal layer LQL (scattering state). The display panel P2 controls the transparent state and the scattering state by controlling the alignment of the liquid crystal LQ in the propagation path of the light L50. In the scattering state, the light L50 is emitted from the front surface 30f side toward the outside of the display panel P2 as the emitted light L2 by the liquid crystal LQ.

Further, the background light incident from the back surface 10b side passes through the substrate 10, the liquid crystal layer LQL, the substrate 20, and the light guide plate 30, and is emitted from the front surface 30f side toward the outside. The emitted light L2 and the background light are visually recognized by the observer residing on the side provided with the front surface 30f. The observer can recognize the emitted light L2 and the background light in combination. Such a display panel that enables the observer to recognize a display image and a background in an overlapping state is called a transparent display panel.

Next, a configuration example of a circuit included in the display panel P2 illustrated in FIG. 3 will be described. FIG. 5 is a circuit block diagram illustrating an example of a circuit included in the display panel in FIG. 3. The wiring path connected to a common electrode CE illustrated in FIG. 5 is formed on, for example, the substrate 10 or the substrate 20 illustrated in FIG. 4. In FIG. 5, a common potential line CML connected to the common electrode CE is illustrated by the dotted line. In the example illustrated in FIG. 5, the light source control unit 52 is provided separately from the drive circuit 70.

In the example illustrated in FIG. 4, the light source control unit 52 is connected to the wiring board 53. The light source control unit 52 may be directly formed on the wiring board 53, for example. Alternatively, the light source control unit 52 may be formed in a not-illustrated electronic component, and the electronic component may be mounted on the wiring board 53. In the example illustrated in FIG. 4, the wiring board 11 is connected to the substrate 10. The control unit 90 is connected to the wiring board 11. The control unit 90 includes a control circuit 91 that supplies a control signal to the drive circuit 70 and a signal processing circuit 92. The wiring board 11 is, for example, a wiring board having flexibility called a flexible wiring board.

In the example illustrated in FIG. 5, the drive circuit 70 includes a pixel control circuit 71, a gate drive circuit 72, a source drive circuit 73, and a common potential drive circuit 74. The drive circuit 70 (in particular, the gate drive circuit 72, the source drive circuit 73, and the common potential drive circuit 74) is a drive circuit that supplies a signal for driving the liquid crystal layer LQL illustrated in FIG. 4. In the example illustrated in FIG. 5, the configuration example in which the pixel control circuit 71 is included in the drive circuit 70 is illustrated, but there are various modifications in the allocation of the circuits included in the drive circuit 70 and the control unit 90. For example, the pixel control circuit 71 may be included in the control unit 90.

The control circuit 91 of the control unit 90 is a circuit that controls display of an image. The signal processing circuit 92 includes an input signal analysis unit (input signal analysis circuit) 921, a storage unit (storage circuit) 922, and a signal conditioning unit 923. An input signal VS is input from the control circuit 91 into the input signal analysis unit 921 of the signal processing circuit 92. The input signal analysis unit 921 performs analysis processing on the basis of the input signal VS input from the outside, and generates an input signal VCS. The input signal VCS is, for example, a signal that determines what grayscale value is given to each pixel of the display panel P2 (see FIG. 3) on the basis of the input signal VS.

The signal conditioning unit 923 generates an input signal VCSA from the input signal VCS input from the input signal analysis unit 921. The signal conditioning unit 923 transmits the input signal VCSA to the pixel control circuit 71 via a wiring path such as the wiring board 11 (see FIG. 4). In other words, the control circuit 91 of the control unit 90 supplies a control signal to the drive circuit 70 via the signal processing circuit 92. In addition, the signal conditioning unit 923 transmits a light source control signal LCSA to the light source control unit 52. The light source control signal LCSA is, for example, a signal including information about the light amount of the light source unit 50 set according to the grayscale value input into the pixel.

The light source control unit 52 outputs a signal for driving each of the plurality of light emitting elements 51 included in the light source unit 50 to the light source unit 50 via a wiring path such as the wiring board 53 (see FIG. 4). In the example illustrated in FIG. 5, the light source unit 50 includes, for example, a light emitting element 51r capable of emitting red light, a light emitting element 51g capable of emitting green light, and a light emitting element 51b capable of emitting blue light. Each of the plurality of light emitting elements 51 is, for example, a light emitting diode element.

The pixel control circuit 71 generates a horizontal drive signal HDS and a vertical drive signal VDS on the basis of the input signal VCSA. For example, in the present embodiment, since the driving is performed by the field sequential system, the horizontal drive signal HDS and the vertical drive signal VDS are generated for each color that can be emitted by the light source unit 50. The gate drive circuit 72 sequentially selects gate lines GL of the display panel P2 (see FIG. 3) in one vertical scanning period on the basis of the horizontal drive signal HDS. The order of selection of the gate lines GL is freely determined. As illustrated in FIG. 3, the plurality of gate lines (signal lines) GL extends in the X direction and are arranged along the Y direction.

The source drive circuit 73 supplies a grayscale signal corresponding to an output grayscale value of each pixel to each source line SL of the display panel P2 (see FIG. 3) in one horizontal scanning period on the basis of the vertical drive signal VDS. As illustrated in FIG. 3, the plurality of source lines (signal lines) SL extends in the Y direction and are arranged along the X direction. One pixel is formed for each intersection of the gate line GL and the source line SL. The switching element Tr (see FIG. 5) is formed in each portion where the gate line GL and the source line SL intersect with each other. The plurality of gate lines GL and the plurality of source lines SL illustrated in FIGS. 3 and 5 correspond to the plurality of signal lines for transmitting the drive signal for driving the liquid crystal LQ illustrated in FIG. 4.

For example, a thin film transistor is used as the switching element Tr illustrated in FIG. 5. The type of the thin film transistor is not limited to a particular type, and for example, the following can be given as examples. When classified by the position of the gate, a bottom gate type transistor or a top gate type transistor can be given. When classified by the number of gates, a single-gate thin film transistor and a double-gate thin film transistor can be given. One of the source electrode and the drain electrode of the switching element Tr is connected to the source line SL, the gate electrode is connected to the gate line GL, and the other of the source electrode and the drain electrode is connected to one end of the capacitor of the polymer dispersed liquid crystal LC (liquid crystal LQ illustrated in FIG. 4). The capacitor of the polymer dispersed liquid crystal LC has one end connected to the switching element Tr via a pixel electrode PE, and the other end connected to the common potential line CML via the common electrode CE. In addition, holding capacitance HC is generated between the pixel electrode PE and a holding capacitance electrode electrically connected to the common potential line CML. Note that the potential supplied to the common potential line CML is supplied from the common potential drive circuit 74.

### Details of Light Guide Plate

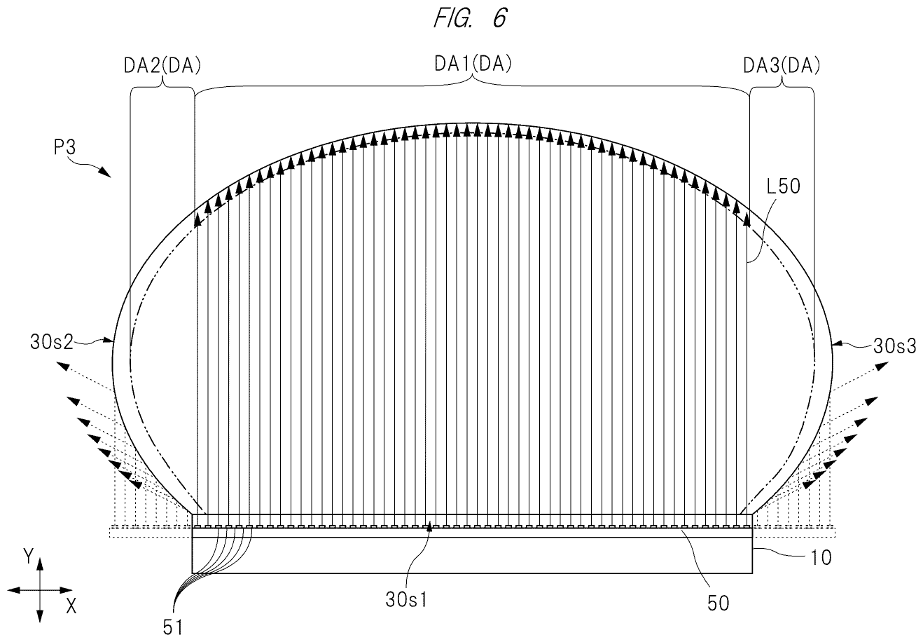

Next, details of the light guide plate will be described. FIG. 6 is a plan view schematically illustrating a path of light entering the light guide plate in a display panel, which is an examination example with respect to FIG. 3.

The light guide plate 30 of a display panel P3 illustrated in FIG. 6 includes a side surface 30s1 facing the light source unit 50 and extending along a first direction, a side surface 30s2 continuous with one end of the side surface 30s1 and forming a curved surface, and a side surface 30s3 continuous with the other end of the side surface 30s1 and forming a curved surface. In the examples illustrated in FIGS. 3 and 6, the light guide plate 30 includes a side surface 30s4 on the opposite side of the side surface 30s1. The side surface 30s4 also forms a curved surface. In this respect, the display panel P3 is similar to the display panel P2 illustrated in FIG. 3. However, the display panel P3 is different from the display panel P2 illustrated in FIG. 3 in that the entire side surface 30s1 facing the light source unit 50, out of the plurality of side surfaces of the light guide plate, is a flat surface. In other respects, the display panel P3 and the display panel P2 are similar to each other, and thus redundant description is omitted.

As illustrated in FIG. 6, in the case of the display panel P3, the light L50 emitted from each of the plurality of light emitting elements 51 of the light source unit 50 is incident from the side surface 30s1 and linearly travels along the Y direction. Here, suppose that the display area DA is divided into a display area DA1 facing the light source unit 50 and having the side surface 30s1, a display area DA2 having the side surface 30s2, and a display area DA3 having the side surface 30s3.

As described above, in the case of the display panel P3, since the light L50 linearly travels along the Y direction, the luminance of the display area DA1 is extremely higher than the luminance of the display area DA2 and the display area DA3. In other words, since the light L50 does not sufficiently reach the display area DA2 and the display area DA3, the luminance of the display area DA2 and the display area DA3 is low, and the display area DA2 and the display area DA3 are displayed to be dark.

In addition, as a result of experimental confirmation by the inventor of the present application, it has been found that, even in a case where the range of the light source unit 50 is extended and the light source unit 50 is arranged so that the side surface 30s2 or the side surface 30s3 is arranged in front of the light emitting elements 51 in the Y direction as illustrated by the dotted lines in FIG. 6, the luminance of the display area DA2 and the display area DA3 is low. This is considered to be caused by part or all of the light L50 being reflected due to a small incident angle when the light L50 enters the side surface 30s2 or the side surface 30s3.

Specifically, the plurality of light emitting elements 51 is linearly arranged along the X direction, for example. Therefore, the light L50 incident on the side surface 30s1 perpendicular to the Y direction is hardly reflected, and almost every piece of the light L50 enters the light guide plate 30. On the other hand, the side surface 30s2 and the side surface 30s3 are not perpendicular to the Y direction. Therefore, depending on the incident angle of the light L50, part or all of the light L50 is reflected by the side surface 30s2 or the side surface 30s3, and the amount of light entering the light guide plate 30 is small. As a result, sufficient luminance cannot be obtained in the display area DA2 and the display area DA3.

In the display panel P2 illustrated in FIG. 3 and the display panel P3 illustrated in FIG. 6, it is preferable to make the luminance uniform from the viewpoint of improving the display quality. In order to make the luminance uniform, it is necessary to reduce non-uniformity of the density of the light incident on the light guide plate. Specifically, in a case where the luminance of the display area DA is made uniform, a structural feature for supplying the light L50 to the display area DA2 and the display area DA3 is required. Hereinbelow, a detailed structure of the display panel P2 illustrated in FIG. 3 will be described.

FIG. 7 is an enlarged plan view illustrating, in an enlarged manner, a periphery of one end portion of the side surface facing the light source unit in the light guide plate illustrated in FIG. 3. FIG. 8 is an enlarged plan view illustrating, in an enlarged manner, a periphery of the other end portion of the side surface facing the light source unit in the light guide plate illustrated in FIG. 3.

The light guide plate 30 of the display panel P2 illustrated in FIG. 3 includes the side surface 30s1 facing the light source unit 50 and extending along the first direction, the side surface 30s2 continuous with one end of the side surface 30s1 and forming a curved surface, and the side surface 30s3 continuous with the other end of the side surface 30s1 and forming a curved surface. In this respect, the display panel P2 is similar to the display panel P3 illustrated in FIG. 6.

The side surface 30s1 of the light guide plate 30 of the display panel P2 includes a region R1, a region R2 located between the region R1 and the side surface 30s2 and continuous with the side surface 30s2, and a region R3 located between the region R1 and the side surface 30s3 and continuous with the side surface 30s3. As illustrated in FIGS. 7 and 8, the region R2 (see FIG. 7) and the region R3 (see FIG. 8) each include a plurality of protrusions 33 capable of changing the traveling direction of light.

In the example illustrated in FIGS. 7 and 8, each of the plurality of protrusions 33 is a prism having a conical shape or a pyramid shape. The light L50 incident on one of the plurality of protrusions 33 is refracted in a direction inclined at an angle less than 90 degrees with respect to the Y direction on the surface of the protrusion 33, and then linearly travels in the light guide plate 30. In other words, part of the light L50 is refracted by the protrusion 33 to reach the display area DA2 (see FIG. 7) and the display area DA3 (see FIG. 8). As a result, the luminance of the display area DA2 and the display area DA3 is increased, so that the display quality of the display panel P2 can be improved.

Meanwhile, in the example of the present embodiment, as illustrated in FIGS. 7 and 8, the plurality of protrusions 33 are not formed in the region R1. In other words, the region R1 is a flatter surface than the region R2 and the region R3. From the viewpoint of improving the luminance of the display area DA2 and the display area DA3, the traveling direction of the light L50 incident on the region R2 illustrated in FIG. 7 and the region R3 illustrated in FIG. 8 in the side surface 30s1 is important, and the shape of the region R1 is not limited. For example, as a modification to the present embodiment, there is a case where the plurality of protrusions 33 is formed in the region R1 as well as in the region R2 and the region R3.

However, from the viewpoint of improving the luminance of the entire display panel P2, the region R1 is preferably flat as compared with the region R2 and the region R3 as in the present embodiment. As described above, each of the plurality of protrusions 33 is a prism capable of changing the traveling direction of the light L50. However, not all of the light L50 emitted to the plurality of protrusions 33 may enter the light guide plate 30, and part of the light L50 may be reflected by the surfaces of the protrusions 33.

On the other hand, in a case where the region R1 is a flat surface as in the present embodiment, the region R1 can be arranged so as to be perpendicular to the Y direction, which is a direction from the light source unit 50 (specifically, from each of the plurality of light emitting elements 51) toward the side surface 30s1 of the light guide plate 30. In this case, the light L50 emitted to the region R1 is hardly reflected, and substantially the entire amount enters the light guide plate 30. Therefore, from the viewpoint of the total amount of the light L50 entering the light guide plate 30, the region R1 is preferably a flat surface from the viewpoint of being able to increase the total amount of the light L50.

Furthermore, in the example illustrated in FIG. 3, in the Y direction, which is a direction from the light source unit 50 toward the side surface 30s1 of the light guide plate 30, the side surface 30s2 and the side surface 30s3 are each arranged at a position not facing the light source unit 50. As a modification to the present embodiment, as illustrated by the dotted line in FIG. 6, the light source unit can be extended so that the side surface 30s2 and the side surface 30s3 can be arranged at positions facing the light source unit 50 in the Y direction. However, as described above, according to the examination of the inventor of the present application, it is found that, even if the length of the light source unit 50 is extended in the X direction, a sufficient amount of the light L50 is not supplied to the display area DA2 and the display area DA3. Therefore, in a case where each of the side surface 30s2 and the side surface 30s3 is arranged at a position not facing the light source unit 50 as in the present embodiment, the number of the light emitting elements 51 to be used can be reduced, which is preferable from the viewpoint of cost or power consumption reduction.

### Details of Example of Shape of Protrusion

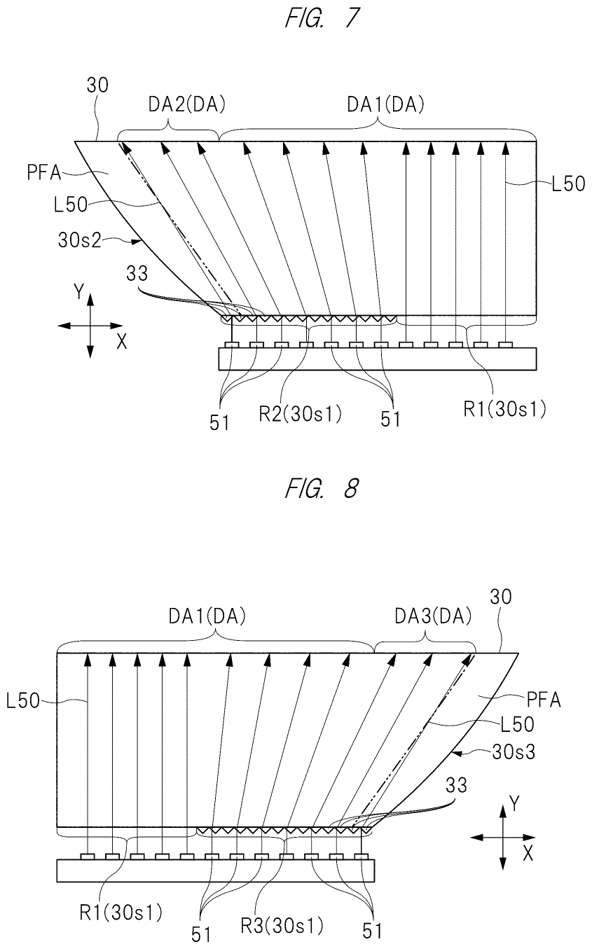

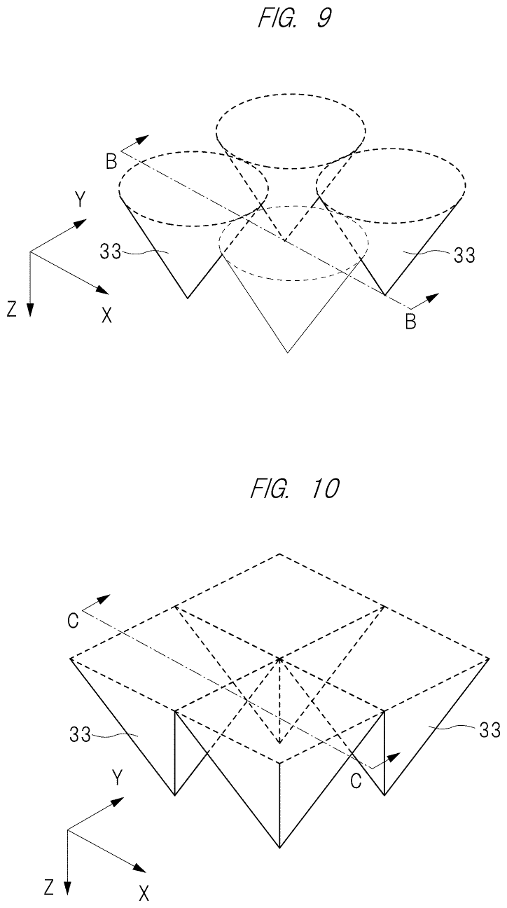

Next, an example of the shape of the protrusion 33 will be described. Each of FIGS. 9 and 10 is a perspective view illustrating an example of the plurality of protrusions formed on the light guide plate. FIG. 11 is an enlarged cross-sectional view taken along line B-B in FIG. 9 or line C-C in FIG. 10. An enlarged cross section taken along line B-B in FIG. 9 and an enlarged cross section taken along line C-C in FIG. 10 both have the shape illustrated in FIG. 11.

In the example illustrated in FIG. 9, each of the plurality of protrusions 33 has a conical shape. In the example illustrated in FIG. 10, each of the plurality of protrusions 33 has a pyramid shape. Although a quadrangular pyramid is illustrated as an example of the pyramid shape in FIG. 10, a triangular pyramid or a polygonal pyramid such as a five-or-more-sided pyramid may be used as a modification. As illustrated in FIG. 11, each of the plurality of protrusions 33 forms a triangle in a cross-sectional view along the X-Y plane. One of the three sides of the triangle is arranged along the X direction. The other two of the three sides of the triangle are arranged so as to extend along directions intersecting with the X direction and the Y direction, respectively.

As schematically illustrated in FIG. 11, the light L50 emitted from the light source unit 50 (specifically, the light emitting element 51) travels along the Y direction and is emitted to the protrusion 33. Part of the light L50 is refracted by the inclined surface of the protrusion 33, and travels in a direction different from the Y direction and the X direction as light L51. In addition, other part of the light L50 is reflected a plurality of times by the inclined surface of the protrusion 33 and travels in a direction of returning toward the light source unit 50 as light L52 illustrated by the dotted line in FIG. 11.

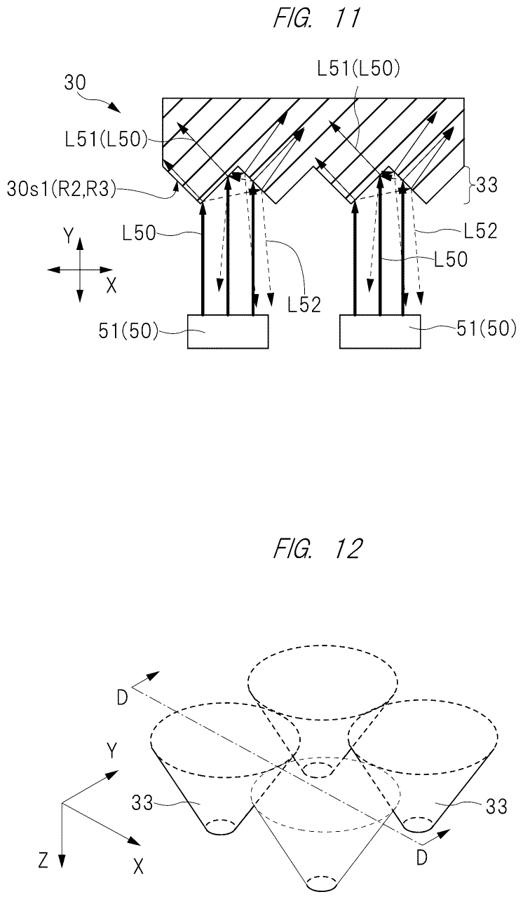

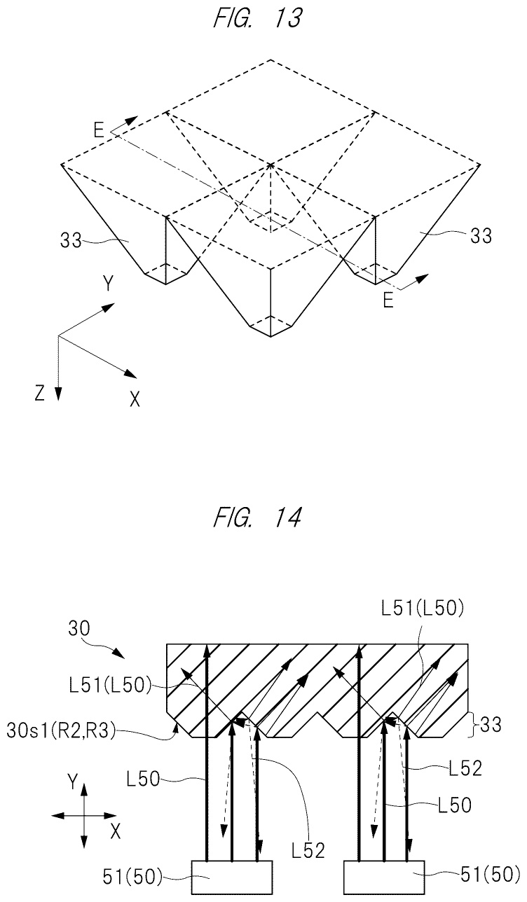

Each of FIGS. 12 and 13 is a perspective view illustrating a modification of the plurality of protrusions formed on the light guide plate. FIG. 14 is an enlarged cross-sectional view taken along line D-D in FIG. 12 or line E-E in FIG. 13. An enlarged cross section taken along line D-D in FIG. 12 and an enlarged cross section taken along line E-E in FIG. 13 both have the shape illustrated in FIG. 14.

In the example illustrated in FIG. 12, each of the plurality of protrusions 33 has a truncated conical shape. In the example illustrated in FIG. 13, each of the plurality of protrusions 33 has a truncated pyramid shape. As illustrated in FIG. 14, top surfaces (upper bases of trapezoids) of the plurality of protrusions 33 face the light source unit 50. In a cross-sectional view along the X-Y plane, each of the plurality of protrusions 33 forms a trapezoid. The upper base and the lower base of the trapezoid are each arranged along the X direction. The other two of the four sides of the trapezoid are arranged so as to extend along directions intersecting with the X direction and the Y direction, respectively.

As schematically illustrated in FIG. 14, the light L50 emitted from the light source unit 50 (specifically, the light emitting element 51) travels along the Y direction and is emitted to the protrusion 33. Part of the light L50 is refracted by the inclined surface of the protrusion 33, and travels in a direction different from the Y direction and the X direction as light L51. In addition, other part of the light L50 is reflected a plurality of times by the inclined surface of the protrusion 33 and travels in a direction of returning toward the light source unit 50 as the light L52 illustrated by the dotted line in FIG. 14.

In addition, as illustrated in FIG. 14, in a case where each of the plurality of protrusions 33 forms a trapezoid in the cross-sectional view, part of the light L50 is emitted to the upper base of the trapezoid. The upper base of the trapezoid is arranged so as to be perpendicular to the traveling direction of the light L50. In this case, since reflection hardly occurs at the upper base of the trapezoid, the amount of light entering the light guide plate 30 can be increased as compared with the example illustrated in FIG. 11.

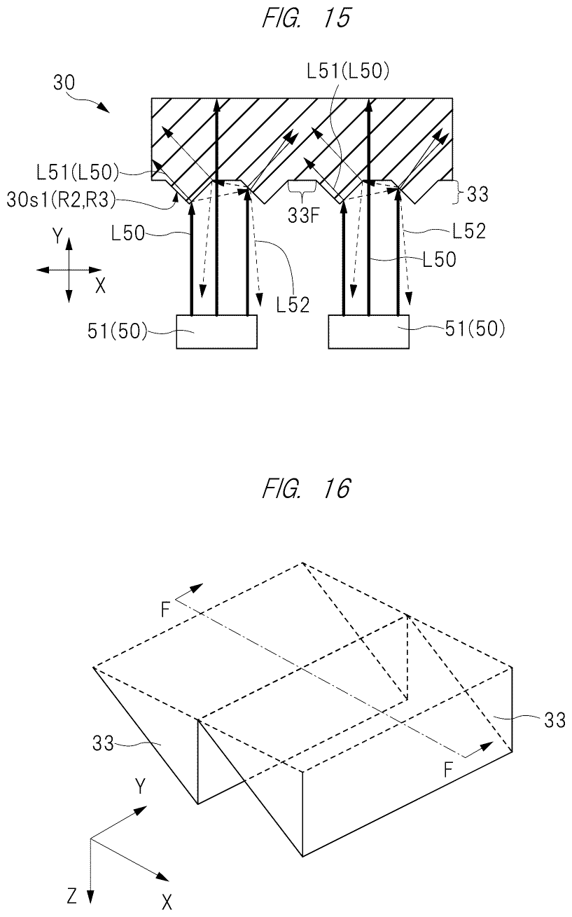

FIG. 15 is an enlarged cross-sectional view illustrating a modification of the plurality of protrusions illustrated in FIG. 11. The layout according to the modification illustrated in FIG. 15 is different from the layout illustrated in FIG. 11 in that a flat part (flat portion 33F) is provided between the plurality of protrusions 33 adjacent to each other. Specifically, the region R2 and the region R3 on the side surface 30s1 each include a flat part between the plurality of protrusions 33 adjacent to each other.

As schematically illustrated in FIG. 15, the light L50 emitted from the light source unit 50 (specifically, the light emitting element 51) travels along the Y direction and is emitted to the protrusion 33. Part of the light L50 is refracted by the inclined surface of the protrusion 33, and travels in a direction different from the Y direction and the X direction as light L51. In addition, other part of the light L50 is reflected a plurality of times by the inclined surface of the protrusion 33 and travels in a direction of returning toward the light source unit 50 as the light L52 illustrated by the dotted line in FIG. 14.

In addition, as illustrated in FIG. 15, in a case where the flat part (flat portion 33F) is provided between the plurality of protrusions 33 adjacent to each other, part of the light L50 is emitted to the flat portion 33F. The flat portion 33F is arranged so as to be perpendicular to the traveling direction of the light L50. In this case, since reflection hardly occurs at the flat portion 33F, the amount of light entering the light guide plate 30 can be increased as compared with the example illustrated in FIG. 11.

Note that FIG. 15 has been described as a modification to FIG. 11, but can be combined with the modification illustrated in FIG. 14 as a further modification to the modification illustrated in FIG. 15. That is, there is a case where each of the plurality of protrusions 33 has a truncated conical shape or a truncated pyramid shape, and the flat portion 33F illustrated in FIG. 15 is arranged between the plurality of adjacent protrusions. In this case, the amount of light entering the light guide plate 30 can be further increased. On the other hand, the amount of the light L51 traveling in a direction different from the Y direction and the X direction is smaller than in the example illustrated in FIG. 14 and the example illustrated in FIG. 15.

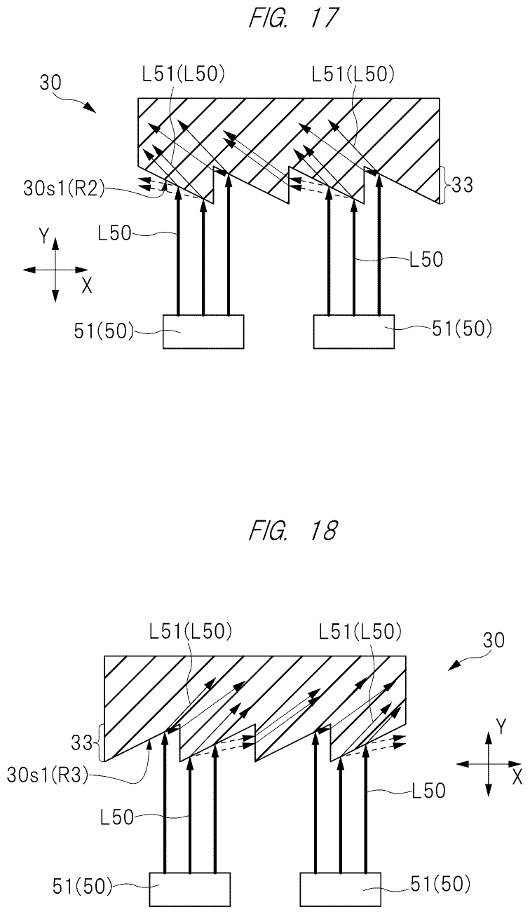

FIG. 16 is a perspective view illustrating another modification of the plurality of protrusions illustrated in FIG. 12. FIG. 17 is an enlarged cross-sectional view taken along line F-F in FIG. 16. FIG. 18 is an enlarged cross-sectional view illustrating an example of a shape of a protrusion in a region opposite the region illustrated in FIG. 17. Each of the plurality of protrusions 33 illustrated in FIGS. 16 to 18 is different from the plurality of protrusions 33 illustrated in FIGS. 12 to 14 in that a cross-sectional shape forms a shape of a saw blade. FIGS. 16 and 17 illustrate an example of the shape of the protrusion 33 arranged in the region R2 illustrated in FIG. 7 as an example. In the present modification, the shape of the protrusion 33 arranged in the region R3 illustrated in FIG. 8 is illustrated in FIG. 18.

In the example illustrated in FIGS. 17 and 18, each of the plurality of protrusions 33 forms a triangle in a cross-sectional view (specifically, a cross-sectional view along the X-Y plane including the X direction and the Y direction). One of the three sides of the triangle is arranged along the X direction. Another one of the three sides of the triangle is arranged along the Y direction. Further, the remaining one of the three sides of the triangle extends in a direction intersecting with the X direction and the Y direction.

As schematically illustrated in FIGS. 17 and 18, the light L50 emitted from the light source unit 50 (specifically, the light emitting element 51) travels along the Y direction and is emitted to the protrusion 33. Part of the light L50 is refracted by the inclined surface of the protrusion 33, and travels in a direction different from the Y direction and the X direction as light L51. In addition, other part of the light L50 is reflected by the inclined surface of the protrusion 33.

However, in the case of the present modification, most of the light reflected by the inclined surface of the protrusion 33 enters the light guide plate 30 from the surface along the Y direction. Therefore, in the case of the present modification, the light L52 illustrated by the dotted line in FIGS. 11, 14, and 15 is hardly generated. In other words, according to the present modification, since most of the light L50 emitted from the light source unit 50 (specifically, the light emitting element 51) enters the light guide plate 30, the luminance can be the highest among those in the plurality of embodiments described above in a case where the amount of the light L50 is the same.

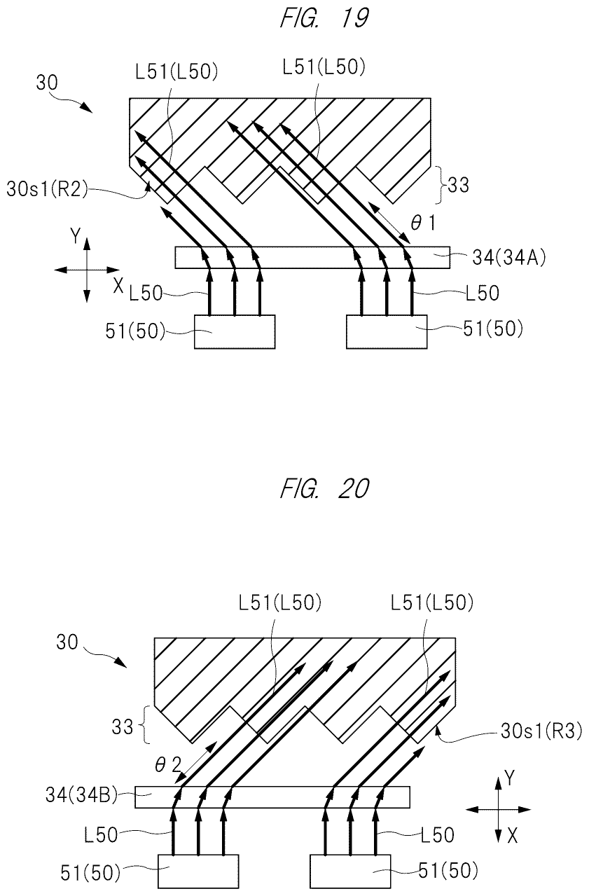

FIGS. 19 and 20 are enlarged cross-sectional views illustrating another modification to FIG. 11. FIG. 19 is an enlarged cross-sectional view of the region R2 illustrated in FIG. 7, and FIG. 20 is an enlarged cross-sectional view of the region R3 illustrated in FIG. 8.

The example illustrated in FIGS. 19 and 20 is different from the embodiment illustrated in FIG. 11 in that a lens 34 is arranged between the light guide plate 30 and the light source unit 50. In the case of the example illustrated in FIGS. 19 and 20, the display device further includes the lens 34 arranged between the side surface 30s1 of the light guide plate 30 and the light source unit 50. As illustrated in FIGS. 19 and 20, the light L50 emitted from the light source unit 50 travels along the Y direction from the light source unit 50 to the lens 34, and travels along a direction inclined with respect to the Y direction (θ1 direction in FIG. 19 and θ2 direction in FIG. 20) from the lens 34 to the light guide plate 30.

In the case of the present modification, in FIGS. 19 and 20, the light L50 can be incident in a direction perpendicular to the inclined surfaces of the plurality of protrusions 33. Therefore, in the case of the present modification, the light L52 illustrated by the dotted line in FIGS. 11, 14, and 15 is hardly generated. In other words, according to the present modification, since most of the light L50 emitted from the light source unit 50 (specifically, the light emitting element 51) enters the light guide plate 30 via the lens 34, the luminance can be the highest among those in the plurality of embodiments described above in a case where the amount of the light L50 is the same.

Note that the direction in which the light L50 is refracted in the region R2 illustrated in FIG. 19 is different from that in the region R3 illustrated in FIG. 20. Therefore, a lens 34A illustrated in FIG. 19 and a lens 34B illustrated in FIG. 20 have different optical characteristics. Specifically, the lens 34A illustrated in FIG. 19 has an optical characteristic of refracting the light L50 so that the light travels toward the left side of the drawing sheet. On the other hand, the lens 34B illustrated in FIG. 20 has an optical characteristic of refracting the light L50 so that the light travels toward the right side of the drawing sheet. In this case, in the display panel P2 illustrated in FIG. 3, the light L51 is supplied to the display area DA2 via the lens 34A illustrated in FIG. 19, and the light L51 is supplied to the display area DA3 via the lens 34B illustrated in FIG. 20.

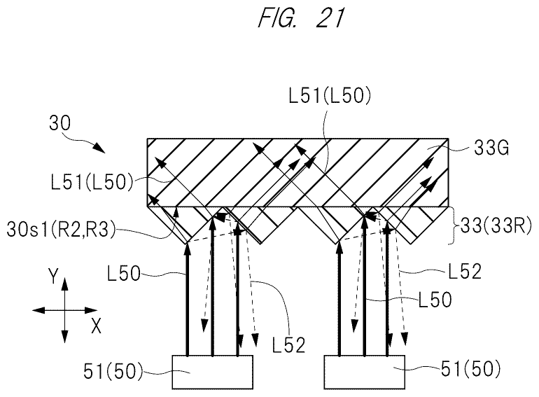

FIG. 21 is an enlarged cross-sectional view illustrating another modification to FIG. 11. The modification illustrated in FIG. 21 is different in that each of the plurality of protrusions 33 is formed separately from a substrate (glass substrate 30G) constituting the light guide plate 30. Each of the plurality of protrusions 33 described with reference to FIGS. 11 to 20 is formed integrally with a substrate (for example, a glass substrate) of the light guide plate 30. Therefore, each of the plurality of protrusions 33 is made of, for example, glass.

On the other hand, in the modification illustrated in FIG. 21, the light guide plate 30 includes the glass substrate 30G and a light transmissive resin layer 30R formed on the glass substrate 30G. Each of the plurality of protrusions 33 includes the light transmissive resin layer 30R.

In a case where each of the plurality of protrusions 33 is formed separately from the glass substrate 30G as in the present modification, the degree of freedom in selecting the material for the protrusion 33 is improved. In addition, in a case where the resin layer 30R is used as the protrusion 33, the protrusion 33 is easily molded, and the degree of freedom of the shape of the protrusion 33 is improved. Note that, in FIG. 21, the modification to FIG. 11 is illustrated as a representative example, but there is a case where any set of the plurality of protrusions 33 illustrated in FIGS. 14, 15, and 17 to 20 includes the resin layer 30R (see FIG. 21).

As described above, the present modification is preferable from the viewpoint of improving the degree of freedom in selecting the material for the protrusion 33 or the degree of freedom of the shape of the protrusion 33. On the other hand, in a case where the protrusion 33 is made of a material different from the glass substrate 30G, the light L51 may be refracted at the interface between the protrusion 33 and the glass substrate 30G. From the viewpoint of preventing refraction of the light L51, each of the plurality of protrusions 33 is preferably formed integrally with the glass substrate 30G.

Although the embodiment and the representative modifications have been described above, the above-described technique can be applied to various modifications other than the illustrated modifications. For example, the above-described modifications may be combined.

Within the scope of the idea of the present invention, those skilled in the art can conceive various changes and modifications, and it is understood that the changes and modifications also fall within the scope of the present invention. For example, as long as the gist of the present invention is included, those in which a person skilled in the art appropriately adds, deletes, or changes in design the components to, or adds, omits, or changes in condition the processes to the respective embodiments described above are also included in the scope of the present invention.

What is claimed is:

1. A display device comprising:
a first substrate including a first front surface and a first back surface on an opposite side of the first front surface;
a liquid crystal layer arranged on the first front surface of the first substrate;
a light guide plate including a second back surface facing the first front surface with the liquid crystal layer interposed therebetween and a second front surface on an opposite side of the second back surface;
a display area located at a position overlapping with a part of the light guide plate; and
a light source unit including a plurality of light emitting elements,
wherein the light guide plate includes
a first side surface facing the light source unit and extending along a first direction,
a second side surface continuous with a first end of the first side surface and forming a curved surface, and
a third side surface continuous with a second end of the first side surface and forming a curved surface,
wherein the first side surface includes
a first region,
a second region located between the first region and the second side surface and continuous with the second side surface, and
a third region located between the first region and the third side surface and continuous with the third side surface, and
wherein the second region and the third region each include a plurality of protrusions capable of changing a traveling direction of light.

2. The display device according to claim 1, wherein the first region is a flatter surface than the second region and the third region.

3. The display device according to claim 2,
wherein, in a second direction from the light source unit toward the first side surface of the light guide plate, each of the second side surface and the third side surface is arranged at a position not facing the light source unit.

4. The display device according to claim 3, wherein each of the plurality of protrusions has a conical shape or a pyramid shape whose vertex faces the light source unit.

5. The display device according to claim 3, wherein each of the plurality of protrusions has a truncated conical shape or a truncated pyramid shape whose top surface faces the light source unit.

6. The display device according to claim 3, wherein the second region and the third region of the first side surface each include a flat part between the plurality of protrusions adjacent to each other.

7. The display device according to claim 3, wherein, in a cross-sectional view, each of the plurality of protrusions forms a triangle,
wherein one of three sides of the triangle is arranged along the first direction, and
wherein another one of the three sides of the triangle is arranged along the second direction.

8. The display device according to claim 3, further comprising:
a lens arranged between the first side surface of the light guide plate and the light source unit,
wherein light emitted from the light source unit travels along the second direction from the light source unit to the lens, and travels along a third direction inclined with respect to the second direction from the lens to the light guide plate.

9. The display device according to claim 1,
wherein the light guide plate includes
a glass substrate, and
a light transmissive resin layer formed on the glass substrate, and
wherein each of the plurality of protrusions includes the light transmissive resin layer.
